(19) United States
(12) Patent Application Publication
(10) Pub. No.: US 2002/0058529 A1
(43) Pub. Date: May 16, 2002

(54) PORTABLE DATA PROCESSOR WITH MOBILE COMMUNICATION UNIT

(76) Inventors: KENZO HORIE, YOKOHAMA (JP); MICHIYOSHI KUDOU, YOKOHAMA (JP)

Correspondence Address: MORRIS LISS, POLLOCK VANDE SANDE & PRIDDY, P O BOX 19088, WASHINGTON, DC, 200363425

(21) Appl. No.: 09/218,022

(22) Filed: Dec. 22, 1998

(30) Foreign Application Priority Data
Dec. 26, 1997 (JP) 9-369626

(51) Int. Cl. H04M 1/00

(52) U.S. Cl. 455/556; 455/550

(57) ABSTRACT

A portable data processor such as a personal digital assistant (PDA) which is designed to perform a data processing function and a mobile communication function is provided. The data processor has a touch sensitive display for data entry and display installed in a top surface of a body and a microphone and a speaker installed in a back surface of the body. These arrangements allow a user to take up the PDA without passing it from one hand to the other hand when a telephone call is received on a desk, for example.

### BACKGROUND OF THE INVENTION

1 Technical Field of the Invention

The present invention relates generally to an improved structure of a portable data processor such as a personal digital assistant (PDA) which is designed to perform a data processing function and a mobile communication function.

2 Background Art

FIGS. 27 and 28 show a conventional personal digital assistance (PDA) 50 with a cellular phone system. The PDA 50 has a body 51 which has disposed on an upper surface 51a thereof a touch sensitive display 52 for data entry and display and a cover 53 for covering the touch sensitive display 52. The body 51 has also disposed in the upper surface 51a a microphone 55 and a speaker 56 for use in mobile communications.

When a telephone call is received, a calling party is represented on a screen 52 of the touch sensitive display 52. The user opens the cover 53 to see the calling party displayed on the screen 52, pushes a telephone button 52A, takes up the body 51, and brings it to the side of a face of the user for establishing communication with the calling party. In a case where the PDA 50 is placed on, for example, a desk with the cover 53 closed, it is necessary for the user to take up the PDA 50 by one hand and pass it to the other hand to bring the microphone 55 and the speaker 56 to the side of the face of the user. It is also necessary for the user to open the cover 53 to perceive the calling party visually. These are quite inconvenience.

The cover 53 is connected to a rear wall of the body 51 through a hinge 58 and locked by a lock mechanism 59 into the body 51. The lock mechanism 59 has, as shown in FIG. 29, a lock claw 60 formed on a reverse surface of the cover 53 and a hook 61 installed in the body 51 for engagement with the lock claw 60. This structure, however, has the drawback in that the degree of engagement of the hook 61 with the claw 60 is not constant, and the hook 61 tends to slip off the claw 60.

### SUMMARY OF THE INVENTION

It is therefore a principal object of the present invention to avoid the disadvantages of the prior art.

It is another object of the present invention to provide an improved structure of a portable data processor which is convenience in using a data entry and display system and a built-in mobile communication system.

According to one aspect of the present invention, there is provided a portable data processor designed to perform a data processing function and a mobile communication function which comprises: (a) a body having a given length and upper and bottom walls; (b) a touch sensitive display disposed in the upper wall of the body for data entry and display; (c) a cover hingedly connected to the body to cover the touch sensitive display; (d) an operating button installed in a portion of the cover above the touch sensitive display to apply pressure to the touch sensitive display; (e) a voice input device installed in the bottom wall of the body to input a voice signal in execution of the mobile communication function; and (f) a voice output device installed in the bottom wall of the body at a given interval away from the voice input device to output a voice signal in execution of the mobile communication function.

In the preferred mode of the invention, a transparent window is further provided which is disposed in the upper wall of the body through which the touch sensitive display is visible.

The button has a given length and has formed thereon a contact protrusion at one end and an attachment protrusion at the other end. The cover has formed therein a recess which has formed in a bottom thereof a contact protrusion opening through which the contact protrusion of the button extends toward the touch sensitive display and an attachment protrusion opening within which the attachment protrusion of the button is retained so as to produce a gap between the bottom of the recess and the button which allows the contact protrusion to be elastically moved into engagement with the touch sensitive display in response to pressure applied to the button.

The button has formed around the attachment protrusion a rib. The cover has formed in the bottom of the recess an inclined wall and a groove in which the rib of the button is fitted so as to hold a portion of the button around the contact protrusion at a given distance away from the inclined wall of the bottom of the recess.

A leaf spring may be disposed between the button and the recess of the cover.

The leaf spring may have formed thereon a protrusion. A diaphragm may be disposed within a recess formed in the inclined wall of the bottom of the recess of the cover in constant engagement with the protrusion of the leaf spring.

A lock mechanism may be provided which locks the cover closed. The lock mechanism includes a lock protrusion formed on the cover and a protrusion holder provided in the body. The lock protrusion has a length extending along a first direction in which the cover is opened and closed and has formed in sides thereof undercuts. The protrusion holder includes a pair of curved arms having ends opposed to each other with a gap therebetween. The curved arms is elastically moved in a second direction perpendicular to the first direction to allow the lock protrusion to be forced into the gap between the curved arms.

The protrusion holder includes a mount plate on which the curved arms are mounted. The mount plate has a curved end and is disposed within a chamber formed in the body with the curved end hanging over an upper corner of the chamber.

### BRIEF DESCRIPTION OF THE DRAWINGS

The present invention will be understood more fully from the detailed description given hereinbelow and from the accompanying drawings of the preferred embodiment of the invention, which, however, should not be taken to limit the invention to the specific embodiment but are for explanation and understanding only.

In the drawings:

FIG. 1 is a perspective view which shows a portable data processor according to the present invention;

FIG. 2 is a perspective view which shows a bottom of the portable data processor in FIG. 1;

FIG. 3 is a perspective view which shows a portable data processor whose cover is opened;

FIG. 4 is a side view which shows a portable data processor whose cover is opened;

FIG. 5 is a perspective view which shows a portable data processor whose a cover is fully opened;

FIG. 6 is a perspective view which shows a portable data processor when a cover is fully closed;

FIG. 7 is a top view which shows a portable data processor;

FIG. 8 is a plan view which shows a reverse surface of a cover;

FIG. 9 is a perspective view which shows a portable data processor grasped by a hand of a user when receiving a telephone call;

FIG. 10 is an illustration which shows a microphone and a speaker installed in a back surface of a portable data processor;

FIG. 11 is a cross sectional view which shows a button mount structure of a cover;

FIG. 12 is a top view which shows a button installed in a cover;

FIG. 13 is a cross sectional view which shows a structural relation between a button and a touch sensitive display;

FIG. 14 is a cross sectional view which shows a touch sensitive display pressed by a button;

FIG. 15 is a partially perspective view which shows a hook of a lock mechanism provided on a cover;

FIG. 16 is a partially perspective view which shows a holder of a lock mechanism provided in a body of a portable data processor;

FIG. 17(a) is a cross sectional view which shows a lock mechanism immediately before a cover is locked;

FIG. 17(b) is a cross sectional view taken along the line T-T in FIG. 17(a);

FIG. 18(a) is a cross sectional view which shows a lock mechanism when a cover is locked;

FIG. 18(b) is a cross sectional view taken along the line U-U in FIG. 18(a);

FIG. 19 is a cross sectional view which shows a first modification of a button mount structure of a cover;

FIG. 20 is a top view which shows a button installed in the cover in FIG. 19;

FIG. 21 is a cross sectional view which shows a structural relation between a button and a touch sensitive display;

FIG. 22 is a cross sectional view which shows a touch sensitive display pressed by a button;

FIG. 23 is a cross sectional view which shows a second modification of a button mount structure of a cover;

FIG. 24 is a top view which shows a button installed in the cover in FIG. 23;

FIG. 25 is a cross sectional view which shows a structural relation between a button and a touch sensitive display;

FIG. 26 is a cross sectional view which shows a touch sensitive display pressed by a button;

FIG. 27 is a perspective view which shows a conventional personal digital assistant (PDA) with a cellular phone system;

FIG. 28 is a perspective view which shows the PDA in FIG. 27 when a cover is opened; and

FIG. 29 is a cross sectional view which shows a lock mechanism of a cover.

### DESCRIPTION OF THE PREFERRED EMBODIMENT

Referring now to the drawings, wherein like numbers refer to like parts in several views, particularly to FIGS. 1 to 3, there is shown a portable data processor 100 such as a personal digital assistant (PDA) which is designed to perform both a data entry and display function and a mobile communication function (i.e., a cellular phone system).

The portable data processor 100 includes a box-like body 1. The body 1 has disposed in a top wall 1a a touch panel 2 (i.e., touch sensitive display), a pictogram liquid-crystal display (LCD) 2-1, and a cover 3 covering the touch panel 2 and also installed, as shown in FIG. 10, in a side wall 1c a telescopic antenna 4 for radio communications.

The touch panel 2 includes a display screen 2B and an operation button array 2c. The operation button array 2c consists of mail, personal communication, telephone (2A), address, system control, schedule, clock, and optical communication buttons.

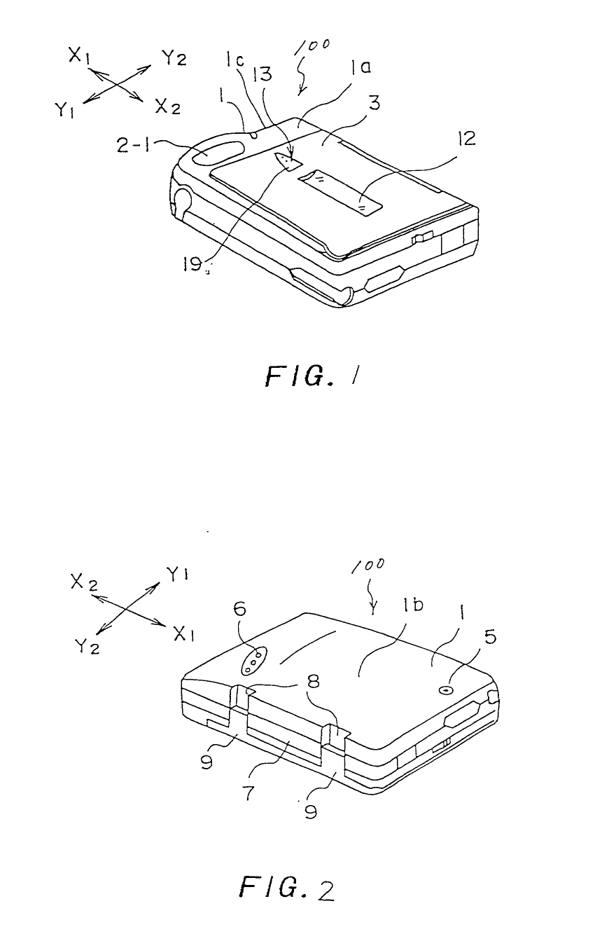

The body 1 has also, as shown in FIGS. 2 and 10, disposed in a bottom wall 1b a microphone 5 and a speaker 6. The microphone 5 is located at left one of four corners, as viewed in FIG. 2, of the bottom wall 1b near a back wall 7 of the body 1, while the speaker 6 is located at another corner diagonally opposite the microphone 5.

The portable data processor 100, as discussed here, is designed for persons who usually hold a receiver of a telephone set by the right hand. For persons who usually hold the receiver by the left hand, it is advisable that the microphone 5 be located at right one of the four corners, as viewed in FIG. 2, of the bottom wall 1b near the back wall 7, and the speaker 6 be located at another corner diagonally opposite the microphone 5.

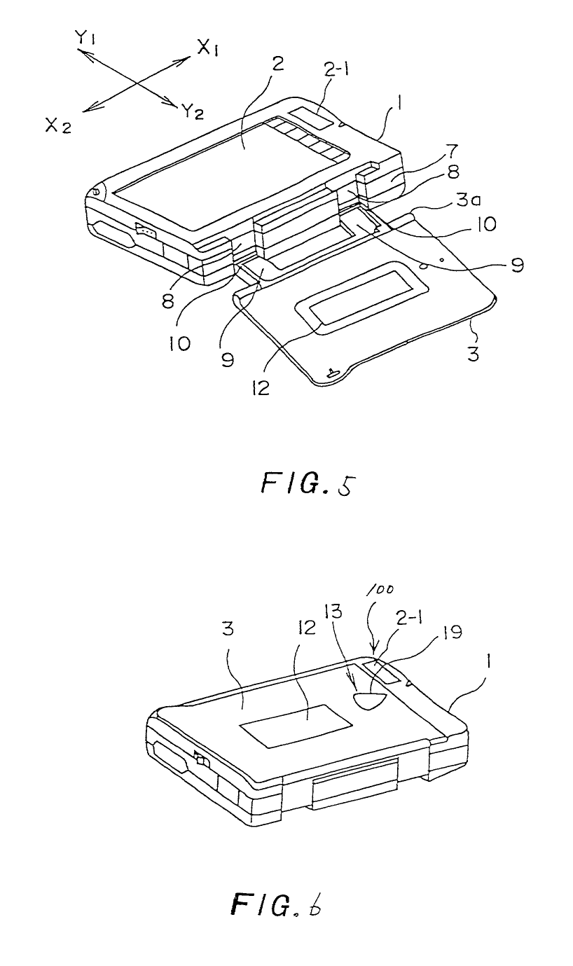

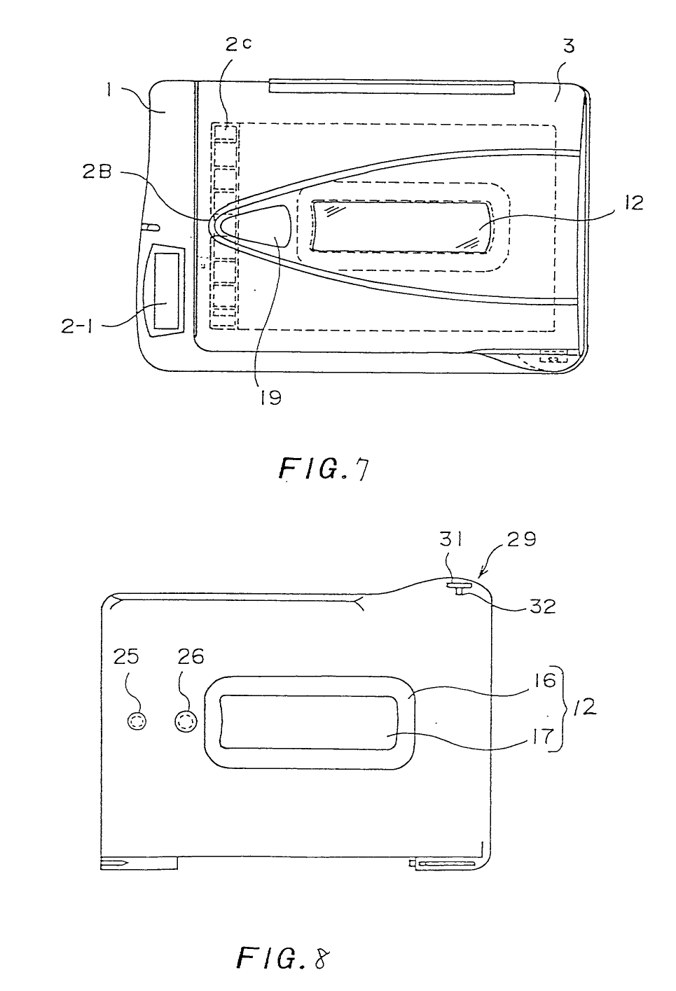

The back wall 7 has formed therein a pair of grooves 8 for installation of hinges 9. The hinges 9 are pivotably supported by a pin 10, as shown in FIG. 4, traversing through mid portions of the grooves 8 so as to allow the cover 3 to be rotated manually by a user. The cover 3 is, as clearly shown in FIGS. 4 and 5, supported at a base edge 3a by the hinges 9 pivotably through a pin 11.

The cover 3 has disposed therein a window 12 through which the user sees the touch panel 2, an operation button mechanism 13 for operating the touch panel 2 when the cover 3 is closed, and a locking mechanism 14 for locking the cover 3 closed.

The window 12 includes, as shown in FIG. 8, a transparent rectangular plate 17 installed on a reverse surface of the cover 3 through a sealing member 16 over an opening formed in the central portion of the cover 3.

The operation button mechanism 13, as shown in FIGS. 11 to 14, consists of a button 19 installed detachably in a button mount 18 formed in a front surface of the cover 3. The button mount 18 is provided on the left side of the cover 3 and includes a recess 20, a contact hole 21, and a button attachment hole 22. The recess 20 is in the form of an isosceles triangle similar to the button 19. The contact hole 21 is formed in the apex of the triangle. The button attachment hole 22 is formed near the center of the base of the triangle. The recess 20 includes a level button wall 15 in which the button attachment hole 21 is formed and a sloping bottom wall 23 sloping from the level button wall 15 toward the contact hole 21.

The contact hole 21, as clearly shown in FIG. 11, consists of an opening 21A and a circular recess 21B formed in the reverse surface 3B of the cover 3 coaxially with the opening 21A. The button attachment hole 22 consists of an opening 22A and a circular recess 22B formed in the reverse surface 3B of the cover 3 coaxially with the opening 22A. A U-shaped rib groove 24 is formed in an edge of the level bottom wall 15.

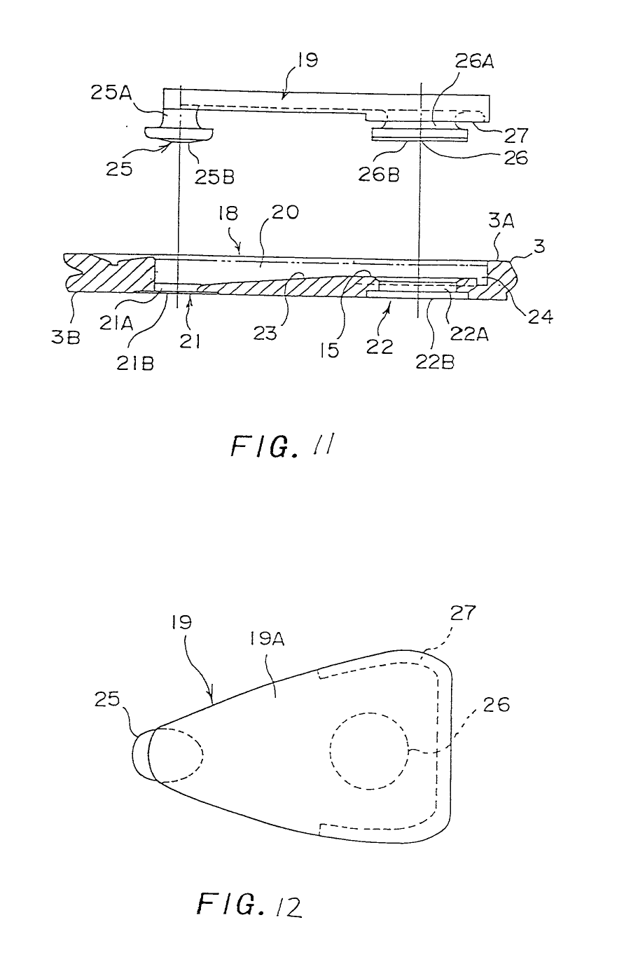

The button 19 is made of an elastic member such as silicone rubber having a hardness of 60 to 80 or of a thermoplastic elastomer having a similar hardness. The button 19, as shown in FIGS. 11 and 12, is in the form of an isosceles triangle and has disposed thereon a contact protrusion 25 and an attachment protrusion 26. The contact protrusion 25 has a convex contact 25B attached to an end of a shaft 25A formed on a bottom surface of the button 19. The attachment protrusion 26 has a flange 26B formed on an end of a shaft 26A formed on the bottom surface of the button 19. The button 19 has also formed on a portion of the periphery around the attachment protrusion 26 a support rib 27 for engagement with the rib groove 24 of the button mount 18.

The attachment protrusion 26 of the button 19, as clearly shown in FIG. 13, is installed in the button attachment hole 22 of the cover 3 with the flange 26B disposed in the circular recess 22B formed in the reverse surface 3B of the cover 3. Similarly, the contact 25B of the contact protrusion 25 is installed in the contact hole 21 with the contact 25B disposed on the circular recess 21B formed in the reverse surface 3B of the cover 3. The support rib 27 is fitted in the rib groove 24 of the button mount 18 so as to hold the button 19 substantially flush with the upper surface of the cover 3 with a gap 28 between a portion of the button 19 near the contact protrusion 25 and the sloping bottom wall 23 of the button mount 18 of the cover 3. This structure allows the button 19 to have substantially the same thickness as that of the cover 3.

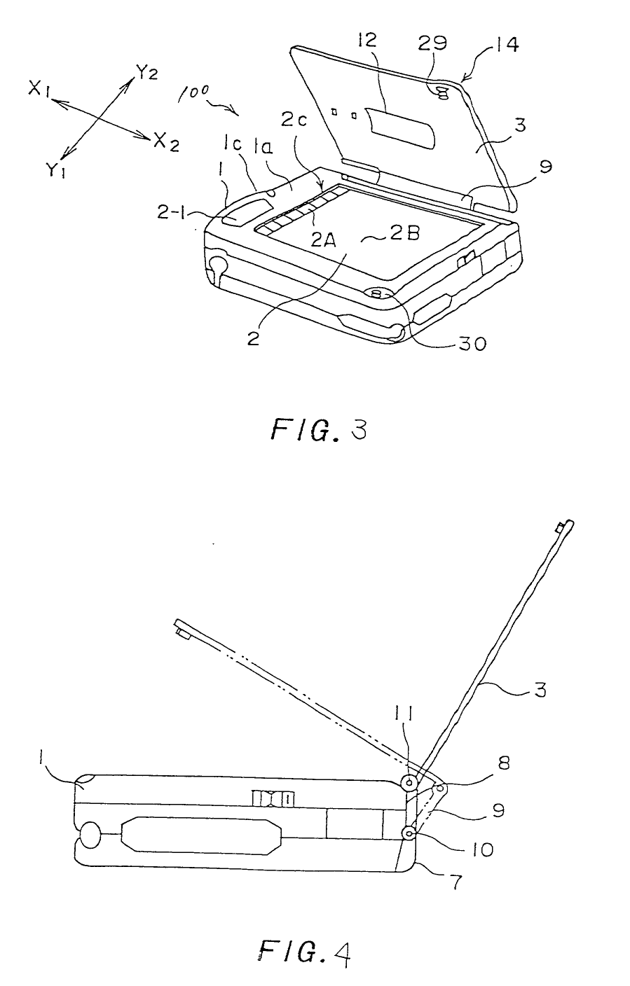

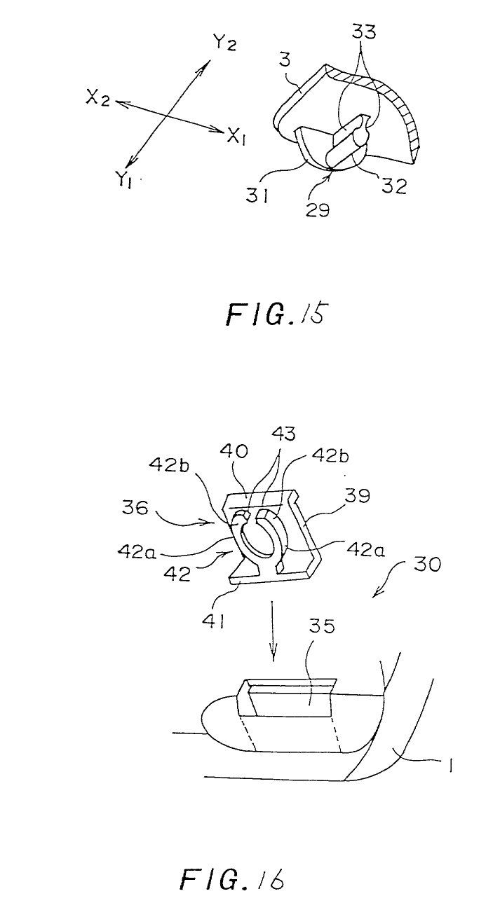

The locking mechanism 14, as shown in FIG. 3, consists of a hook 29 provided on the cover 3 and a hook catcher 30 installed in the body 1. The hook 29 is formed integrally on the front right corner of the reverse surface of the cover 3 and includes, as shown in FIG. 15, a half-moon reinforcement rib 31 extending in a lengthwise direction of the body 1 (i.e., direction X1-X2) and a strip protrusion 32 extending in a widthwise direction of the body 1 (i.e., direction Y1-Y2. The strip protrusion 32 has a length several times the thickness of a catcher 42, as will be described later in detail in FIG. 16, to secure engagement of the strip protrusion 32 with the catcher 42 regardless of any shift or play of the cover 3 when closed fully. The strip protrusion 32 has formed in both side walls undercuts 33 so as to have a mushroom shape in cross section. The hook catcher 30, as shown in FIG. 16, consists of a holder chamber 35 formed in the front surface of the body 1 and a holder 36 fitted in the holder chamber 35. The holder chamber 35, as shown in FIGS. 17(a) and 17(b), has a length extending in the direction X1-X2 and has a shoulder 37 and a barbed portion 38 formed on an upper end of the back wall 35A and the inner front wall 35B, respectively. The holder 36 is made from POM (polyacetal resin) or PA (polyamide resin) which has the wear resistance, elasticity, and slidability and includes an L-shaped mount plate 39 which has a bent portion 40 and a base 41. The base 41 has formed thereon a C-shaped catcher 42 which consists of a pair of curved arms 41a having formed on ends thereof claws 42b. The claws 42b have formed thereon guide surfaces 43 opposed to each other.

The holder 36 is, as shown in FIGS. 17(b) and 17(b), fitted in the holder chamber 35 with the bent portion 40 hanging on the shoulder 37 and a stem 42c of the curved arms 42a engaging the barbed portion 38 formed on the inner front wall 35B of the holder chamber 35. The hanging of the bent portion 40 on the shoulder 37 avoids direct contact of the protrusion 32 of the hook 29 with the upper corner of the back wall 35A of the holder chamber 35 when the cover 3 is closed, thereby preventing a coating on the upper corner of the back wall 35A from peeling off.

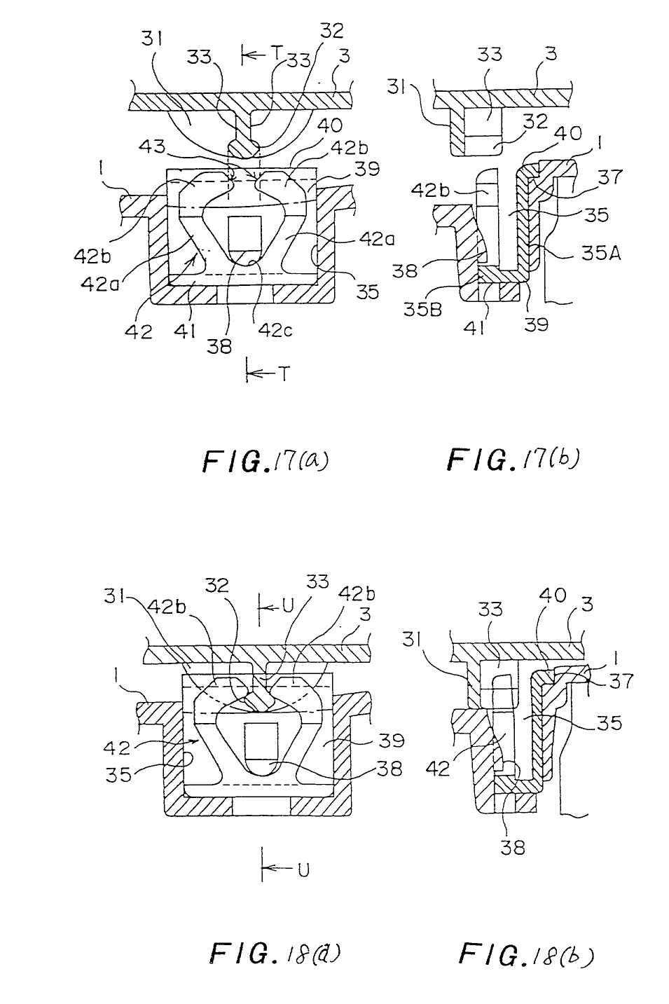

The cover 3 may be opened in two angular ranges, as shown in FIGS. 3, 4, and 5. The first angular range, as illustrated in FIGS. 3 and 4, allows the cover 3 to pivot about the pin 11 to a given angular position. The second angular range, as illustrated in FIGS. 4 and 5, allows the cover 3 to pivot about the pin 10 to a fully opened position. The closing of the cover 3 may be accomplished manually by rotating the cover 3 in counterclockwise direction, as viewed in FIG. 4. The locking of the cover 3 is achieved by applying the pressure to a portion of the cover 3 above the hook 29 to force the protrusion 32 of the hook 29, as shown in FIGS. 17(a) and 18(a), elastically into a gap between the arms 42a of the catcher 42 to establish tight engagement of the protrusion 32 of the hook 29 with the claws 42b of the catcher 42, as shown in FIGS. 18(a) and 18(b).

When the cover 3 is closed fully, the contact 25B of the button 19 is, as shown in FIGS. 3 and 13, placed above the telephone button 2A.

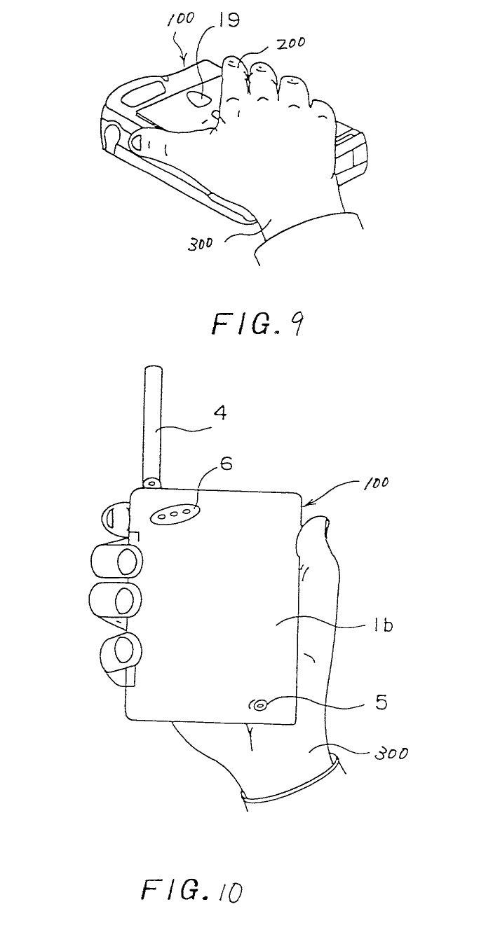

When the portable data processor 100 receives a telephone call, a calling party is indicated on the display screen 2B of the touch panel 2. The user may perceive the calling party visually through the window 12 without opening the cover 3. The user, as shown in FIG. 9, may grasp the portable data processor 100 by the right hand 300 and bring it to the right side of the face with the antenna 4 stood, as shown in FIG. 10. The speaker 6, thus, lies near the right ear, and the microphone 5 lies on the side of the mouth.

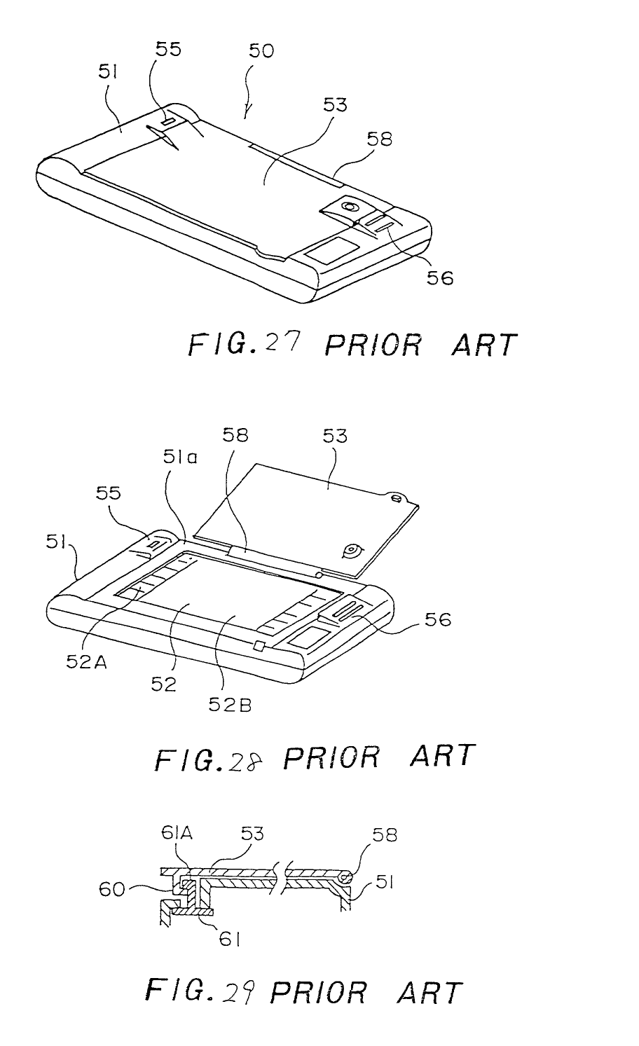

Specifically, the conventional PDA 50, as already discussed with reference to FIGS. 27 and 28, has the microphone 55 and the speaker 56 installed in the top wall thereof. Thus, when the PDA 50 receives a telephone call while it is placed on a desk, for example, it is necessary for the user to take the PDA 50 using the left hand and pass it to the right hand. The portable data processor 100 of this embodiment, however, has the speaker 6 and the microphone 5 installed in the bottom wall and does not encounter the above problem.

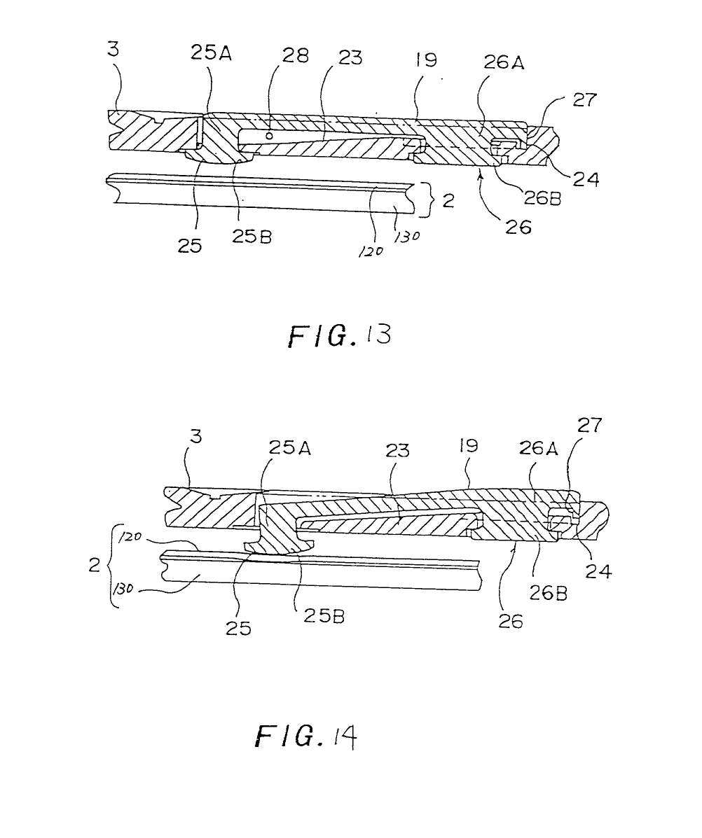

After perceiving the calling party through the window 12 of the cover 3, the user may initiate the communication by pushing a portion of the button 19 above the contact protrusion 25 using the forefinger 200, as shown in FIG. 9, to press the touch panel 2, as shown in FIG. 14, through the contact 25B of the contact protrusion 25, thereby making contact of the upper electrode 120 with the lower electrode 130 of the touch panel 2. Specifically, the application of pressure to the portion of the button 19 above the contact protrusion 25 from the forefinger 200 of the user causes the button 19, as clearly shown in FIG. 14, to be bent elastically downward to urge the contact protrusion 25 into engagement with the touch panel 2.

FIGS. 19 to 22 show a modification of the cover 3.

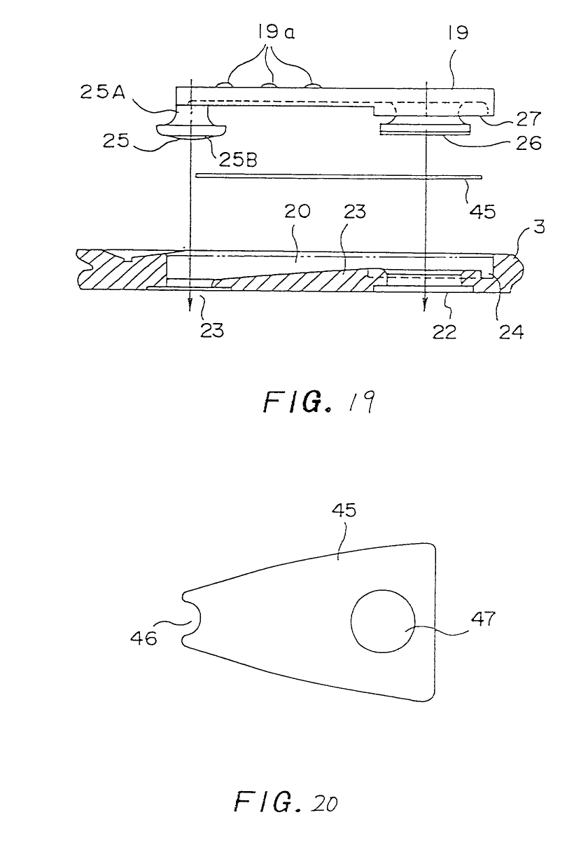

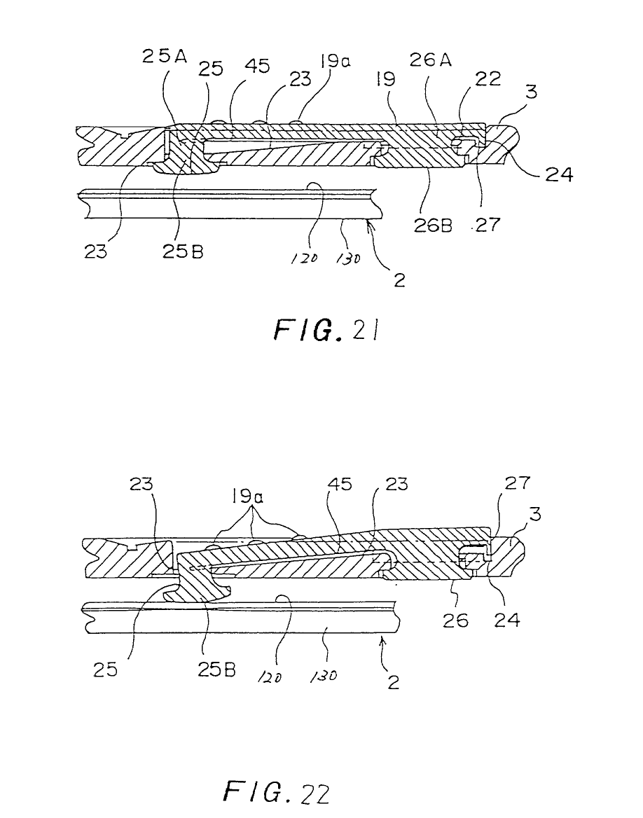

The cover 3 has disposed between the button 19 and the bottom of the recess 20 a leaf spring 45 for compensating for deterioration of material of the button 19 with age and caused by changes in ambient temperature and humidity. The leaf spring 45 is, as clearly shown in FIG. 20, made of a triangular stainless steel having a thickness of about 0.2 mm and has formed therein a half-moon cutout portion 46 for engagement with the shaft 25A of the contact protrusion 25 of the button 19 and a circular opening 47 through which the shaft 26A of the attachment protrusion 26 passes. The leaf spring 45 is, as shown in FIG. 21, retained on the bottom wall of the button 19 by the attachment protrusion 26 and held in orientation by the engagement with the shaft 25A of the contact protrusion 25.

The button 19 may have formed on the upper wall, as shown in FIG. 19, a plurality of protrusions 19a as an indicator indicating a location of a portion of the button 19 above the gap 28 to which the pressure is to be applied from a finger of the user.

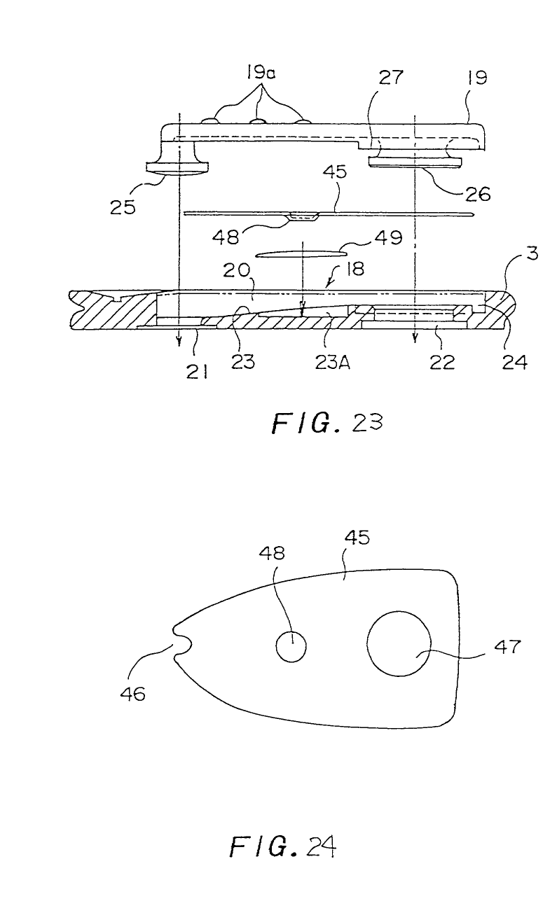

FIGS. 23 to 26 show a second modification of the cover 3.

The leaf spring 45 has formed on a central portion thereof a protrusion 48. The sloping bottom wall 23 of the recess 20 has formed therein a recess 23A in which a diaphragm 49 is disposed.

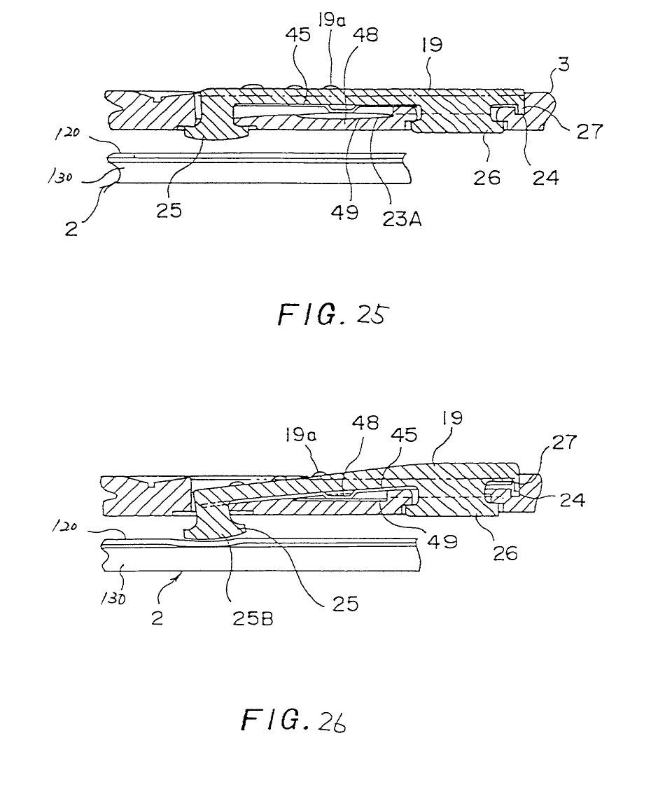

When no pressure is, as shown in FIG. 25, applied to the button 19, the protrusion 48 of the leaf spring 45 is in contact with the diaphragm 49 without urging it downward. When the pressure is, as shown in FIG. 26, applied from the finger of the user to the button 19, the button 19 is elastically bent downward to press the diaphragm 48 through the protrusion 48 of the leaf spring 45 with a click, thereby producing a reactive pressure acting on the finger of the user which will enable the user to physically perceive the depression of the button 19 (i.e., the contact of the upper electrode 120 with the lower electrode 130 of the touch panel 2).

While the present invention has been disclosed in terms of the preferred embodiment in order to facilitate better understanding thereof, it should be appreciated that the invention can be embodied in various ways without departing from the principle of the invention. Therefore, the invention should be understood to include all possible embodiments and modification to the shown embodiments which can be embodied without departing from the principle of the invention as set forth in the appended claims.

What is claimed is:

1. A portable data processor designed to perform a data processing function and a mobile communication function comprising:
a body having a given length and upper and bottom walls;
a touch sensitive display disposed in the upper wall of said body for data entry and display;
a cover hingedly connected to said body to cover said touch sensitive display;
an operating button installed in a portion of said cover above said touch sensitive display to apply pressure to said touch sensitive display;
a voice input device installed in the bottom wall of said body to input a voice signal in execution of the mobile communication function; and
a voice output device installed in the bottom wall of said body at a given interval away from said voice input device to output a voice signal in execution of the mobile communication function.

2. A portable data processor as set forth in claim 1, further comprising a transparent window disposed in the upper wall of said body through which said touch sensitive display is visible.

3. A portable data processor as set forth in claim 1, wherein said button has a given length and has formed thereon a contact protrusion at one end and an attachment protrusion at the other end, and wherein said cover has formed therein a recess which has formed in a bottom thereof a contact protrusion opening through which the contact protrusion of said button extends toward said touch sensitive display and an attachment protrusion opening within which the attachment protrusion of said button is retained so as to produce a gap between the bottom of the recess and said button which allows the contact protrusion to be elastically moved into engagement with said touch sensitive display in response to pressure applied to said button.

4. A portable data processor as set forth in claim 3, wherein said button has formed around the attachment protrusion a rib, and wherein said cover has formed in the bottom of the recess an inclined wall and a groove in which the rib of said button is fitted so as to hold a portion of said button around the contact protrusion at a given distance away from the inclined wall of the bottom of the recess.

5. A portable data processor as set forth in claim 3, further comprising a leaf spring disposed between said button and the recess of said cover.

6. A portable data processor as set forth in claim 5, wherein said leaf spring has formed thereon a protrusion, and further comprising a diaphragm disposed within a recess formed in the inclined wall of the bottom of the recess of the cover in constant engagement with the protrusion of said leaf spring.

7. A portable data processor as set forth in claim 1, further comprising a lock mechanism which locks said cover closed, said lock mechanism including a lock protrusion formed on said cover and a protrusion holder provided in said body, the lock protrusion having a length extending along a first direction in which said cover is opened and closed and having formed in sides thereof undercuts, the protrusion holder including a pair of curved arms having ends opposed to each other with a gap therebetween, the curved arms being elastically moved in a second direction perpendicular to the first direction to allow the lock protrusion to be forced into the gap between the curved arms.

8. A portable data processor as set forth in claim 7, wherein the protrusion holder includes a mount plate on which the curved arms are mounted, the mount plate having a curved end and being disposed within a chamber formed in said body with the curved end hanging over an upper corner of the chamber.
